(19) United States
(12) Patent Application Publication
(10) Pub. No.: US 2024/0167537 A1
(43) Pub. Date: May 23, 2024

(54) SUPPORT SYSTEM AND COMPONENTS THEREOF

(71) Applicant: VAICO LIMITED, Christchurch (NZ)

(72) Inventor: Vincent Alexander HOW, Rangiora (NZ)

(73) Assignee: VAICO 2022 LIMITED, Maungaturoto (NZ)

(21) Appl. No.: 18/279,744

(22) PCT Filed: Mar. 3, 2022
(86) PCT No.: PCT/IB2022/051859

§ 371 Date: Aug. 31, 2023

(30) Foreign Application Priority Data
Mar. 3, 2021 (AU) 2021900588
Aug. 25, 2021 (AU) 2021221696

(51) Int. Cl. F16G 11/14; F16G 11/12; F16G 11/04

(52) U.S. Cl. CPC F16G 11/146; F16G 11/12; F16G 11/04

(57) ABSTRACT

Disclosed is a wire adjustment plate 110 for use with a suspension wire 150 capable of adjusting and setting the effective suspension distance between a structure and an object to be suspended from and by said structure. The plate 110 comprises at least three see-through holes 121, 122, 123 that are positioned, sized and shaped to allow the wire 150 to pass through each hole for suspending the object with equal distribution of force on the plate 110 at each hole.

The present invention relates to a support system and components thereof. More particularly but not exclusively it relates to a support system for holding, hanging (suspending), and/or bracing building components or materials, in particular those used in or for creating ceiling cavities of commercial buildings such as but not exclusively to building services and a components of such a system to an earthquake bracing system.

### BACKGROUND OF THE INVENTION

Use of wires/cables to support an object or an item by bracing, suspending and/or holding is well known. When supporting by bracing, suspending and/or holding an object it often needs to be secured properly. If the item falls or dislodges from the wire/cable it can lead not only to damage of the item but depending upon what the item is, the fall can lead to catastrophic results. This also applies to earthquake bracing systems.

One well known and generally used method of securing the item that is supported by being suspended, braced and/or held by wires is to use crimps, wedge locking devices and/or to form knots. Such methods to secure the item can require specialized knowledge. When using wires/cables for such a purpose, sometimes the ability to adjust the height or length of the wire/cable (but at the same time not compromising its ability to secure the item properly) is also desirable and that can further add to the complexity of the installation. Further, creating the knots for securing the item and undoing the knots for the release of the item can also be a time-consuming process. Crimped wire is even harder to adjust and often is not done so that means that the wire cannot be re-used. This also applies to earthquake bracing systems.

### OBJECT OF THE INVENTION

It is an object of the present invention to provide a support system which overcomes or at least partially ameliorates some of the abovementioned disadvantages and/or which at least provides the public with a useful choice.

Additionally, or alternatively, it is an object of the present invention to provide a component(s) of a support system and/or method associated with the support system and/or components thereof which overcomes or at least partially ameliorates some of the abovementioned disadvantages and/or which at least provides the public with a useful choice.

Additionally, or alternatively, it is an object of the present invention to provide an earthquake bracing system which overcomes or at least partially ameliorates some of the abovementioned disadvantages and/or which at least provides the public with a useful choice.

Additionally, or alternatively, it is an object of the present invention to provide an earthquake bracing system and/or method associated with the earthquake bracing systems and/or components thereof which overcomes or at least partially ameliorates some of the abovementioned disadvantages and/or which at least provides the public with a useful choice.

### Statements of the Invention

In a first aspect, the present invention resides in a wire adjustment plate to be used together with a wire in supporting at least one item by bracing, suspending and/or holding the at least one item, the wire adjustment plate being in a form of a (formed as) single piece plate at a planar surface of which at least three see-through holes are provided, each hole being positioned, sized and shaped (suitably positioned, sized and shaped) to allow the wire to pass through each hole for supporting the at least one item by bracing, holding and/or suspending the at least one item with equal distribution of force on the plate at each hole, wherein the at least three holes are a first hole, a second hole and a third hole, the first hole being located (when in use) above the second and third holes with distances between the first hole and the second hole and the first hole and the third hole being the same.

In one embodiment, each hole is positioned, sized and shaped (suitably positioned, sized and shaped) to allow the wire to pass through each hole so that the wire forms a loop for supporting the at least one item by bracing, holding and/or suspending the at least one item with at least six points of contact between the wire and the plate with two points of contact of the wire with the plate per hole (two points of contact of the wire with the plate at each hole).

In one embodiment, the at least three holes are in symmetry (preferably in perfect symmetry) so that equal force is applied on the plate at each hole.

In one embodiment, wherein the equal distribution of force on the plate at each hole is from a load that is exerted on the wire by the at least one item.

In one embodiment, the wire is a load bearing wire.

In one embodiment, the distances between the first hole and the second hole, the first hole and the third hole, and the second hole and the third hole are the same.

In one embodiment, a total of three holes are present through the plate.

In one embodiment, the at least one item is a building material.

In one embodiment, the holes are round/circular the distances are from the centre of each hole.

In one embodiment, the holes are round/circular and the holes are all of the same diameter.

In one embodiment, the holes define cylindrical shape with the axis of the cylinder parallel a notional normal of the plane of the plate.

In one embodiment, the distances are from their most proximal hole edges of the holes.

In one embodiment, the at least one item is of a pipe or duct.

In one embodiment, the at least one item is a construction material.

In one embodiment, the at least one item is a beam such as of a framework.

In one embodiment, the holes are positioned so as to form a triangular pattern together.

In one embodiment, the holes are positioned so as to form an equilateral triangular pattern together.

In one embodiment, the holes are of the same size.

In one embodiment, the holes are of the same shape.

In one embodiment, each hole is circular in shape.

In one embodiment, the diameter of each hole is above 1 mm and below 11 mm.

In one embodiment, the diameter of each hole is above 1 mm and below 7 mm.

In one embodiment, the diameter of each hole is above 1 mm and below 5 mm.

In one embodiment, the diameter of each hole is above 1 mm.

In one embodiment, the diameter of each hole is or is about 2 mm or 3 mm.

In one embodiment, an effective suspension distance is able to be varied by the plate.

In one embodiment, the diameter of each hole is or is about 4 mm.

In one embodiment, the diameter of each hole is or is about 4 mm for a wire of diameter between 1 mm to 1.6 mm to pass through.

In one embodiment, the diameter of each hole is or is about 5 mm.

In one embodiment, the diameter of each hole is or is about 5 mm for a wire of diameter between 2 mm to 2.4 mm to pass through.

In one embodiment, the diameter of each hole is or is about 6 mm.

In one embodiment, the diameter of each hole is or is about 6 mm for a wire of diameter between 3 mm to 3.2 mm to pass through.

In one embodiment, the diameter of each hole is or is about 8 mm.

In one embodiment, the diameter of each hole is or is about 8 mm for a wire of diameter between 4 mm to 5 mm to pass through.

In one embodiment, the diameter of each hole is or is about 10 mm.

In one embodiment, the diameter of each hole is or is about 10 mm for a wire of diameter between 6 mm to 6.3 mm to pass through.

In one embodiment, the plate is of uniform (constant) thickness.

In one embodiment, the plate is or is about 2 mm in thickness.

In one embodiment, the plate is or is about 3.5 mm in thickness.

In one embodiment, the plate is or is about 5 mm in thickness.

In one embodiment, the plate is of non-uniform (variable) thickness.

In one embodiment, the plate is or is about 3.5 mm in thickness at a top portion and is or is about 3.4 mm in thickness at a bottom portion.

In one embodiment, the plate is or is about 5 mm in thickness at a top portion and is or is about 4.1 mm in thickness at a bottom portion.

In one embodiment, the plate is a substantially rectangular plate having a first side (first edge), a second side (second edge), a third side (third edge) and a fourth side (fourth edge) wherein the first side and second side are located opposite to one another and the third side and the fourth side are located opposite to one another, wherein the first hole is more proximal to the first side than the second hole, the second hole is more proximal to the second side than the first hole, the second hole is more proximal to the third side than the third hole and the third hole is more proximal to the fourth side than the second hole.

In one embodiment, each corner of the plate is rounded.

In one embodiment, distance between the first hole and the first side is same as the distance between the second hole and the second side.

In one embodiment, distance between the first hole and the first side is same as the distance between the third hole and the second side.

In one embodiment, distance between the second hole and the third side is same as the distance between the third hole and the fourth side.

In one embodiment, distance between the first hole and the first side is same as the distance between the second hole and the third side.

In one embodiment, distance between the first hole and the first side is same as the distance between the third hole and the fourth side.

In one embodiment, each of the first side and the second side is between 30 mm and 80 mm in length.

In one embodiment, each of the first side and the second side is or is about 40 mm in length.

In one embodiment, each of the third side and the fourth side is or is about 30 mm length.

In one embodiment, distance between centre point of the second hole to the third side is or is about 13.5 mm.

In one embodiment, distance between centre point of the third hole to the fourth side is or is about 13.5 mm.

In one embodiment, distance between centre point of the first hole to the second side is or is about 20.7 mm.

In one embodiment, distance between centre point of the first hole to the first side is or is about 9.3 mm.

In one embodiment, each of the first side and second side is or is about 53 mm in length.

In one embodiment, each of the third side and fourth side is or is about 39.8 mm in length.

In one embodiment, distance between centre point of second hole to the third side is or is about 17.9 mm.

In one embodiment, distance between centre point of third hole to the fourth side is or is about 17.9 mm.

In one embodiment, distance between centre point of the first hole to the second side is or is about 12.3 mm.

In one embodiment, distance between centre point of the first hole to the first side is or is about 12.3 mm.

In one embodiment, each of the first side and the second side is or is about 67 mm.

In one embodiment, each of the third side and the fourth side is or is about 50.2 mm.

In one embodiment, distance between centre point of second hole to the third side is or is about 22.65 mm.

In one embodiment, distance between centre point of third hole to the fourth side is or is about 22.65 mm.

In one embodiment, distance between centre point of first hole to the second side is or is about 15.6 mm.

In one embodiment, distance between centre point of first hole to the first side is or is about 15.6 mm.

In one embodiment, distance between centre point of one hole to centre point of another hole is between 7 mm to 23 mm.

In one embodiment, distance between centre point of one hole to centre point of another hole is or is about 8.6 mm.

In one embodiment, distance between centre point of one hole to centre point of another hole is or is about 10.7 mm.

In one embodiment, distance between centre point of one hole to centre point of another hole is or is about 13.12 mm.

In one embodiment, distance between centre point of one hole to centre point of another hole is or is about 17.4 mm.

In one embodiment, distance between centre point of one hole to centre point of another hole is or is about 17.4 mm.

In one embodiment, distance between centre point of one hole to centre point of another hole is or is about 22 mm.

In one embodiment, distance between centre point of one hole to centre point of another hole is or is about 19.1 mm.

In one embodiment, distance between centre point of one hole to centre point of another hole is or is about 21.7 mm.

In one embodiment, distance between centre point of the first hole to centre point of the second hole is or is about 13.12 mm and distance between centre point of the second hole to centre point of third hole is or is about 13 mm.

In one embodiment, distance between centre point of the first hole to centre point of the second hole is or is about 17.4 mm and distance between centre point of the second hole to centre point of the third hole is or is about 17.2 mm.

In one embodiment, distance between centre point of the first hole to centre point of the second hole is or is about 22 mm and distance between centre point of the second hole to centre point of the third hole is or is about 21.7 mm.

In one embodiment, the wire adjustment plate is a metallic plate.

In one embodiment, the wire adjustment plate is resistant to corrosion.

In one embodiment, the wire adjustment plate is made out of or comprises stainless steel.

In one embodiment, the wire adjustment plate is made out of or comprises a galvanized metal.

In one embodiment, the wire adjustment plate has a zinc-plated finish.

In one embodiment, the wire adjustment plate is a 2.5 mm cold rolled Gr300 mild steel plate.

In one embodiment, the wire adjustment plate is made out of or comprises a hot-dip galvanized metal.

In one embodiment, the wire adjustment plate is reusable.

In one embodiment, the wire adjustment plate is the reusable cleat as defined in the tenth aspect below.

In one embodiment, wire adjustment plate is configured to be used together with the wire as part of an earthquake bracing system.

In one embodiment, wire adjustment plate is configured to be used together with the wire as part of a support hanger system.

In one embodiment, the support hanger system is an earthquake bracing system.

In one embodiment, the support hanger system or the earthquake bracing system further comprises at least one bracing member that is coupled to at least one loop formed by the wire at or proximal to one or each end of the support hanger system or the earthquake bracing system.

In one embodiment, the support hanger system or the earthquake bracing system further comprises a first bracing member and a second bracing member, the first bracing member is coupled to a first loop formed by the wire at or proximal to a first end of the support hanger system or the earthquake bracing system, and the second bracing member is coupled to a second loop formed by the wire at or proximal to a second end of the support hanger system or the earthquake bracing system, the second end being opposite the first end.

In one embodiment the at least one bracing member is selected from a hook or a bracket (e.g. 45 degree angled bracket).

In one embodiment, the wire adjustment plate is deformable or bendable.

In one embodiment, wherein the wire adjustment plate is made out of a malleable material thereby allowing the wire adjustment plate to be deformed or bent when the force applied at each or at least one hole exceeds beyond a threshold amount of force.

In one embodiment, the wire adjustment plate is deformed or bent prior to failing or breaking.

In one embodiment, the threshold amount of force is pre-determined.

In a second aspect, the present invention resides in a wire adjustment plate to be used together with a wire in supporting at least one item by bracing, suspending and/or holding the at least one item, the wire adjustment plate being in a form of (formed as) a single piece plate at a planar surface of which at least three see-through holes are defined, the plate being configured to allow the wire to pass through each hole so that the wire forms a loop for supporting the at least one item by bracing, holding and/or suspending the at least one item with at least six points of contact between the wire and the plate with two points of contact of the wire with the plate per hole (two points of contact at each hole),
wherein the at least three holes are a first hole, a second hole and a third hole, the first hole being located (when in use) above the second and third holes with distances between the first hole and the second hole and the first hole and the third hole being the same.

In one embodiment, each hole is positioned, sized and shaped (suitably positioned, sized and shaped) to allow a wire to pass through each hole for supporting the at least one item by bracing, holding and/or suspending the at least one item with equal distribution of force on the plate at each hole.

One or more statements as defined above with respect to the invention as described in the first aspect may equally apply to the invention as described in the second aspect.

In a third aspect, the present invention resides in a wire adjustment plate to be used together with a wire in supporting at least one item by bracing, suspending and/or holding the at least one item, the wire adjustment plate being in a form of (formed as) a single piece plate at a planar surface of which at least three see-through holes are defined, each hole being positioned, sized and shaped (suitably positioned, sized and shaped) to allow the wire to pass through each hole for supporting the at least one item by bracing, holding and/or suspending the at least one item,
wherein the at least three holes are a first hole, a second hole and a third hole, the first hole being located above the second and third holes (when in use),
wherein the at least three holes are in symmetry (preferably in perfect symmetry) so that when the at least one item is added or applied on the wire equal force is applied on the plate at each hole.

One or more statements as defined above with respect to the invention as described in the first aspect may equally apply to the invention as described in the third aspect.

In a fourth aspect, the present invention resides in a wire that is configured to be used together with a wire adjustment plate to support at least one item by bracing, holding and/or suspending the at least one item wherein the wire adjustment plate is in a form of (formed as) a single piece plate at a planar surface of which plate at least three see-through holes are defined, the at least three holes are a first hole, a second hole and a third hole, the first hole being located (when in use) above the second and third holes with distances between the first hole and the second hole and the first hole and the third hole being the same,
wherein, the wire is adapted to pass through each hole so that the wire so that when the at least one item is added or applied on the wire equal force is applied on the plate at each hole.

In one embodiment, the wire forms a loop for supporting the at least one item by bracing, holding and/or suspending the at least one item with at least six points of contact between the wire and the plate with two points of contact per hole (two point of contacts at each hole).

In one embodiment, the wire is a load bearing wire.

In one embodiment, wherein the equal force applied is applied on the plate at each hole is from a load that is exerted on the wire by the at least one item.

In one embodiment, the wire is a steel core wire.

In one embodiment, the wire is a stainless-steel wire.

In one embodiment, the wire is an Aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire is a stretchable wire.

In one embodiment, the wire is configured to be used together with the wire adjustment plate as part of an earthquake bracing system.

In one embodiment, the wire adjustment plate is configured to be used together with the wire adjustment plate as part of a support hanger system.

In one embodiment, the support hanger system is an earthquake bracing system.

In one embodiment, the wire adjustment plate is the one as defined in any one of the above statements.

In one embodiment, the wire adjustment plate is the reusable cleat as defined in the twelfth aspect below.

In a fifth aspect, the present invention resides in a wire that is configured to be used together with a wire adjustment plate to support at least one item by bracing, holding and/or suspending the at least one item wherein the wire adjustment plate is in a form of (formed as) a single piece plate at a planar surface of which at least three see-through holes are defined, the at least three holes are a first hole, a second hole and a third hole, the first hole being located above the second and third holes (when in use) with distances between the first hole and the second hole and the first hole and the third hole being the same,
wherein, the wire is adapted to pass through each hole so that the wire forms a loop for supporting the at least one item bracing, holding and/or suspending the at least one item with at least six points of contact between the wire and the plate with two points of contact of the wire with the plate per hole (two points of contact at each hole).

In one embodiment, the wire is a metallic wire that allows a portion of the wire to clamp between another portion of the wire and the wire adjustment plate with a clamping force that facilitates supporting the at least one item by bracing, holding and/or suspending of the at least one item.

In one embodiment, the wire is a load bearing wire.

In one embodiment, the wire is adapted to pass through each hole so that the wire so that when the at least one item is added or applied on the wire equal force is applied on the plate at each hole.

In one embodiment, wherein the equal force applied on the plate at each hole is from a load that is exerted on the wire by the at least one item.

In one embodiment, the wire is a steel core wire.

In one embodiment, the wire is a stainless-steel wire.

In one embodiment, the wire is an aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire is configured to be used together with the wire adjustment plate as part of an earthquake bracing system.

In one embodiment, the wire adjustment plate is configured to be used together with the wire adjustment plate as part of a support hanger system.

In one embodiment, the support hanger system is an earthquake bracing system.

In one embodiment, the wire adjustment plate is the one as defined in any one of the above statements.

In a sixth aspect, the present invention resides in a support system for supporting at least one item by bracing, suspending and/or holding the at least one item, the system comprising:
a wire adjustment plate that is in a form of (formed as) a single piece plate at a planar surface of which at least three see-through holes are defined, and
a wire to be received through each hole of the wire adjustment plate;
wherein the wire adjustment plate is configured to allow the wire to pass through each hole so that the wire supports the at least one item by bracing, suspending and/or holding the at least one item with equal distribution of force on the plate at each hole,
wherein the at least three holes are a first hole, a second hole and a third hole, the first hole being located above the second and third holes (when in use) with distances between the first hole and the second hole and the first hole and the third hole being the same, and
wherein the wire is a metallic wire that allows a portion of the wire to clamp between another portion of the wire and the wire adjustment plate with a clamping force that facilitates supporting the at least one item by bracing holding and/or suspending of the at least one item.

In one embodiment, the wire is adapted to pass through each hole so that the wire forms a loop for supporting the at least one item by holding and/or suspending the at least one item with at least seven points of contact between the wire and the plate with two points of contact of the wire with the plate per hole (two points of contact at each hole) and a seventh point of contact between the wire and the wire adjustment plate.

In one embodiment, wherein the equal distribution of force on the plate at each hole is from a load that is exerted on the wire by the at least one item.

In one embodiment, each hole is positioned, sized and shaped to allow a wire to pass through each hole for supporting the at least one item by bracing, holding and/or suspending the at least one item with equal distribution of force on the plate at each hole.

In one embodiment, the wire adjustment plate is configured to allow the wire to pass through each hole so that the wire forms a loop for supporting the at least one item by bracing, suspending and/or holding the at least one item with at least six points of contact between the wire and the plate with two points of contact of the wire with the plate per hole (two points of contact at each hole).

In one embodiment, the wire is a steel core wire.

In one embodiment, the wire is a stainless-steel wire.

In one embodiment, the wire is an aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire adjustment plate is the one as defined in any one of the above statements.

In one embodiment, the wire adjustment plate is the reusable cleat as defined in the twelfth aspect below.

In one embodiment, the wire is the one as defined in any one of the above statements.

In one embodiment, the support system is a support hanger system.

In one embodiment, the support system is an earthquake bracing system.

In one embodiment, the support system is a wire based (cable based) system.

In one embodiment, the support system attaches/couples to the at least one item to support the at least one item by bracing, suspending and/or holding the at least one item.

In a seventh aspect, the present invention resides in a support system for supporting at least one item by bracing, suspending and/or holding the at least one item, the system comprising:
a wire adjustment plate that is in a form of (formed as) a single piece plate at a planar surface of which at least three see-through holes are defined, and
a wire to be received through each hole of the wire adjustment plate;
wherein the wire adjustment plate is configured to allow the wire to pass through each hole so that the wire forms a loop for supporting the at least one item by bracing, suspending and/or holding the at least one item with at least six points of contact between the wire and the plate with two points of contact of the wire with the plate per hole (two points of contact at each hole),
wherein the at least three holes are a first hole, a second hole and a third hole, the first hole being located above the second and third holes (when in use) with distances between the first hole and the second hole and the first hole and the third hole being the same, and
wherein, the wire is adapted to pass through each hole so that the wire forms a loop for supporting the at least one item by bracing, holding and/or suspending the at least one item with at least six points of contact between the wire and the plate with two points of contact of the wire with the plate per hole (two points of contact at each hole).

In one embodiment, wherein the wire is a metallic wire that is able to form the loop by clamping a portion of the wire between another portion of the wire and the wire adjustment plate with a clamping force that facilitates supporting the at least one item by bracing, holding and/or suspending of the at least one item.

In one embodiment, the wire adjustment plate is configured to allow the wire to pass through each hole so that the wire supports the at least one item by bracing, holding and/or suspending the at least one item with equal distribution of force on the plate at each hole

In one embodiment, wherein the equal distribution of force on the plate at each hole is from a load that is exerted on the wire by the at least one item.

In one embodiment the clamped portion of the wire is a seventh point of contact between the wire and the wire adjustment plate.

In one embodiment, the wire adjustment plate and/or wire are made from metallic materials.

In one embodiment, the wire is a steel core wire.

In one embodiment, the wire is a stainless-steel wire.

In one embodiment, the wire is an aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire adjustment plate is the one as defined in any one of the above statements.

In one embodiment, the wire adjustment plate is the reusable cleat as defined in the twelfth aspect below.

In one embodiment, the wire is the one as defined in any one of the above statements.

In one embodiment, the support system is a support hanger system.

In one embodiment, the support system is an earthquake bracing system.

In one embodiment, the support system attaches/couples to the at least one item to support the at least one item by bracing, suspending and/or holding the at least one item.

In one embodiment, the support system further comprises at least one bracing member that is coupled to at least one loop formed by the wire at or proximal to one or each end of the support system.

In one embodiment, the support system further comprises a first bracing member and a second bracing member, the first bracing member is coupled to a first loop formed by the wire at or proximal to a first end of the support system and the second bracing member is coupled to a second loop formed by the wire at or proximal to a second end of the support system, the second end being opposite the first end.

In one embodiment the at least one bracing member is selected from a hook or a bracket (e.g. 45 degree angled bracket).

In an eighth aspect, the present invention resides in an earthquake bracing system, the system comprising:
a wire adjustment plate that is in a form of (formed as) a single piece plate at a planar surface of which at least three see-through holes are defined, and
a wire to be received through each hole of the wire adjustment plate;
wherein the wire adjustment plate is configured to allow the wire to pass through each hole so that the wire supports at least one item by bracing, holding and/or suspending the at least one item with equal distribution of force on the plate at each hole,
wherein the at least three holes are a first hole, a second hole and a third hole, the first hole being located above the second and third holes (when in use) with distances between the first hole and the second hole and the first hole and the third hole being the same, and
wherein the wire is a metallic wire that allows a portion of the wire to clamp between another portion of the wire and the wire adjustment plate with a clamping force that facilitates supporting the at least one item by bracing, holding and/or suspending the at least one item.

In one embodiment, wherein the equal distribution of force on the plate at each hole is from a load that is exerted on the wire by the at least one item.

In one embodiment, the wire adjustment plate and/or wire are made from metallic materials.

In one embodiment, the wire is adapted to pass through each hole so that the wire forms a loop for supporting the at least one item by bracing, holding and/or suspending the at least one item with at least seven points of contact between the wire and the plate with two points of contact of the wire with the plate per hole (two points of contact at each hole) and a seventh point of contact between the wire and the wire adjustment plate.

In one embodiment, the wire is adapted to pass through each hole so that the wire forms a loop for supporting at least one item by bracing, holding and/or suspending the at least one item with at least six points of contact between the wire and the plate with two points of contact of the wire with the plate per hole (two points of contact at each hole).

In one embodiment, the wire is a steel core wire.

In one embodiment, the wire is a stainless-steel wire.

In one embodiment, the wire is an aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire adjustment plate is the one as defined in any one of the above statements.

In one embodiment, the wire adjustment plate is the reusable cleat as defined in the twelfth aspect below.

In one embodiment, the wire is the one as defined in any one of the above statements.

In one embodiment, the earthquake bracing system further comprises at least one bracing member that is coupled to at least one loop formed by the wire at or proximal to one or each end of the earthquake bracing system.

In one embodiment, the earthquake bracing system further comprises a first bracing member and a second bracing member, the first bracing member is coupled to a first loop formed by the wire at or proximal to a first end of the earthquake bracing system, and the second bracing member is coupled to a second loop formed by the wire at or proximal to a second end of the earthquake bracing system earthquake bracing system, the second end being opposite the first end.

In one embodiment, the at least one bracing member is selected from a hook or a bracket (e.g. 45 degree angled bracket).

In one embodiment, at least one of the first bracing member and the second bracing member is selected from a hook or a bracket (e.g. 45 degree angled bracket).

In a ninth aspect, the present invention resides in an earthquake bracing system, the system comprising:
a wire adjustment plate that is in a form of (formed as) a single piece plate at a planar surface of which at least three see-through holes are defined, and
a wire to be received through each hole of the wire adjustment plate;
wherein the wire adjustment plate is configured to allow the wire to pass through each hole so that the wire forms a loop for supporting at least one item by bracing, holding and/or suspending the at least one item with at least six points of contact between the wire and the plate with two points of contact of the wire with the plate per hole (two points of contact at each hole),
wherein the at least three holes are a first hole, a second hole and a third hole, the first hole being located above the second and third holes (when in use) with distances between the first hole and the second hole and the first hole and the third hole being the same, and
wherein, the wire is adapted to pass through each hole so that the wire forms a loop for supporting at least one item by bracing, holding and/or suspending the at least one item with at least six points of contact between the wire and the plate with two points of contact of the wire with the plate per hole (two points of contact at each hole).

In one embodiment, wherein the wire is a metallic wire that is able to form the loop by clamping a portion of the wire between another portion of the wire and the wire adjustment plate with a clamping force that facilitates supporting the at least one item by bracing, holding and/or suspending the at least one item.

In one embodiment, the wire adjustment plate is configured to allow the wire to pass through each hole so that the wire supports the at least one item by bracing, holding and/or suspending the at least one item with equal distribution of force on the plate at each hole

In one embodiment, wherein the equal distribution of force on the plate at each hole is from a load that is exerted on the wire by the at least one item.

In one embodiment the clamped portion of the wire is a seventh point of contact between the wire and the wire adjustment plate.

In one embodiment, the wire adjustment plate and/or wire are made from metallic materials.

In one embodiment, the wire is a steel core wire.

In one embodiment, the wire is a stainless-steel wire.

In one embodiment, the wire is an aircraft cable or a pre-stretched Aircraft cable.

In one embodiment, the wire is a 7×7 or 7×19 (steel Core) stainless steel wire rope.

In one embodiment, the wire is a constructed wire.

In one embodiment, the wire adjustment plate is the one as defined in any one of the above statements.

In one embodiment, the wire adjustment plate is the reusable cleat as defined in the twelfth aspect below.

In one embodiment, the wire is the one as defined in any one of the above statements.

In one embodiment, the support system is a support hanger system.

In one embodiment, the support system is an earthquake bracing system.

In a tenth aspect, the present invention resides in a method of using a wire adjustment plate (or a support system, or a support hanger system or an earthquake bracing system) for supporting at least one item by bracing, suspending and/or holding the at least one item, the method comprising:
providing a wire adjustment plate in a form of (formed as) a single piece plate at a planar surface of which at least three see-through holes are defined, wherein the at least three holes are a first hole, a second hole and a third hole, the first hole being located above the second and third holes with distances between the first hole and the second hole and the first hole and the third hole being the same,
providing a wire,
passing the wire through each hole so that the wire supports at least one item by bracing, holding and/or suspending the at least one item with equal distribution of force on the plate at each hole.

In one embodiment, wherein the equal distribution of force on the plate at each hole is from a load that is exerted on the wire by the at least one item.

In one embodiment, the method comprises allowing a portion of the wire to clamp between another portion of the wire and the wire adjustment plate with a clamping force that facilitates supporting the at least one item by bracing, holding and/or suspending of the at least one item.

In one embodiment, the method comprises passing the wire through each hole so that the wire forms a loop. This is preferably for supporting the at least one item by bracing, holding and/or suspending the at least one item with at least six points of contact between the wire and the plate with two points of contact of the wire with the plate per hole (i.e, two points of contact at each hole).

In one embodiment, method comprises passing the wire through each hole so that the wire forms a loop for supporting the at least one item by bracing, holding and/or suspending the at least one item with at least six points of contact between the wire and the plate with two points of contact of the wire with the plate at each hole.

In one embodiment, forming of the loop comprises at least the following steps in a sequential order:
passing a loose end of the wire through a first hole from a rear face side of the plate towards a front face side of the plate wherein the front face side is located opposite the rear face side,
passing the loose end of the wire through the second hole from the front face side towards the rear face side, and
passing the loose end of the wire through the third hole from the rear face side towards the front face side.

In one embodiment, the loose end of the wire is looped around at least a portion of the at least one an item for supporting the at least one item by bracing, suspending and/or holding the at least one item prior to passing the loose end of the wire through the third hole from the rear face side towards the front face side.

In one embodiment, after the loose end of the wire is passed through the third hole from the rear face side towards the front face side, the loose end is passed through underneath an exposed portion of the wire that extends between the first hole and the second hole at the front face side of the plate.

In one embodiment, after the loose end of the wire is passed through the third hole from the rear face side towards the front face side, the loose end is passed through underneath an exposed portion of the wire that extends between the first hole and the second hole at the front face side of the plate so as to cause a portion of the wire located underneath said exposed portion to be clamped between said exposed portion and the front face side of the plate.

In one embodiment, a portion of the wire located underneath said exposed portion when clamped between said exposed portion and the front face side of the plate is a clamped portion of the wire, wherein the clamped portion forms seventh point of contact between the wire and the plate.

In one embodiment, clamping force is higher than the force/load exerted by the at least one item.

In one embodiment, the method comprises engaging the wire via a second loose end of the wire to an external body so that the wire adjustment plate engages with or suspends from the external body.

In one embodiment, the external body is a ceiling of a building.

In one embodiment, the external body is a wall of a building.

In one embodiment, the wire adjustment plate is the one as defined in any one of the above statements.

In one embodiment, the wire adjustment plate is the reusable cleat as defined in the tenth aspect below.

In one embodiment, the wire is the one as defined in any one of the above statements.

In an eleventh aspect, the present invention resides in a method of using a wire adjustment plate (or a support system or a support hanger system or an earthquake bracing system) for supporting at least one item by bracing, suspending and/or holding the at least one item, the method comprising:
providing a wire adjustment plate in a form of (formed as) a single piece plate at a planar surface of which at least three see-through holes are defined, wherein the at least three holes are a first hole, a second hole and a third hole, the first hole being located above the second and third holes with distances between the first hole and the second hole and the first hole and the third hole being the same,
providing a wire,
passing the wire through each hole so that the wire forms a loop for supporting, bracing, holding and/or suspending the at least one item with at least six points of contact between the wire and the plate with two points of contact per hole (or two points of contact of the wire with the plate at each hole).

In one embodiment, the method comprises engaging the wire with the at least one item for supporting, bracing, suspending and/or holding the at least one item prior to forming the loop.

In one embodiment, forming of the loop comprises at least the following steps in a sequential order:
passing a loose end of the wire through a first hole from a rear face side of the plate towards a front face side of the plate wherein the front face side is located opposite the rear face side,
passing the loose end of the wire through the second hole from the front face side towards the rear face side, and
passing the loose end of the wire through the third hole from the rear face side towards the front face side.

In one embodiment, the loose end of the wire is looped around at least a portion of the at least one item for supporting, bracing, suspending and/or holding the at least one item prior to passing the loose end of the wire through the third hole from the rear face side towards the front face side.

In one embodiment, after the loose end of the wire is passed through the third hole from the rear face side towards the front face side, the loose end is passed through underneath of an exposed portion of the wire that extends between the first hole and the second hole at the front face side of the plate.

In one embodiment, after the loose end of the wire is passed through the third hole from the rear face side towards the front face side, the loose end is passed through underneath of an exposed portion of wire that extends between the first hole and the second hole at the front face side of the plate so as to cause a portion of the wire located underneath said exposed portion to be clamped between said exposed portion and the front face side of the plate.

In one embodiment, a portion of the wire located underneath said exposed portion when clamped between said exposed portion and the front face side of the plate is a clamped portion of the wire, wherein the clamped portion forms a seventh point of contact between the wire and the plate.

In one embodiment, clamping force is higher than the force/load exerted by the at least one item.

In one embodiment, the method comprises engaging the wire via a second loose end of the wire to an external body so that the wire adjustment plate engages with or suspends from the external body.

In one embodiment, the external body is a ceiling of a building.

In one embodiment, the external body is a wall of a building.

In one embodiment, the wire adjustment plate is the one as defined in any one of the above statements.

In one embodiment, the wire adjustment plate is the reusable cleat as defined in the tenth aspect below.

In one embodiment, the wire is the one as defined in any one of the above statements.

In a twelfth aspect, the present invention resides in a re-usable cleat or a plate for use with a suspension cable/wire capable of adjusting and setting the effective suspension distance between a structure and an object to be suspended from and by said structure, the cleat or the plate comprising at least three see-through holes, each hole being positioned, sized and shaped (suitably positioned, sized and shaped) to allow the wire to pass through each hole for suspending the object with equal distribution of force on the cleat or the plate at each hole,
wherein the at least three holes are a first hole, a second hole and a third hole, the first hole being located (when in use) above the second and third holes with distances between the first hole and the second hole and the first hole and the third hole being the same.

In one embodiment, an effective suspension distance is able to be varied by the cleat or the plate.

In one embodiment, wherein the equal distribution of force on the cleat or the plate at each hole is from a load that is exerted on the wire by the object.

In one embodiment, the cleat or the plate is the wire adjustment plate as defined by one or more of the above statements above.

In a thirteenth aspect, the present invention resides in an overhead building structure comprising a ceiling cavity within which a building material is suspended from the structure by a support system wherein the support system is the one as defined by one or more of the statements above.

In a fourteenth aspect, the present invention resides in an overhead building structure comprising a ceiling cavity within which a building material is suspended from the structure by an earthquake bracing system wherein the earthquake bracing system is the one as defined by one or more of the statements above.

In the above, one or more statements as defined above with respect to the invention as described in one aspect may equally apply to the invention as described in another aspect.

Other aspects of the invention may become apparent from the following description which is given by way of example only and with reference to the accompanying drawings.

The entire disclosures of all applications, patents and publications, cited above and below, if any, are hereby incorporated by reference.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

As used herein the term “and/or” means “and” or “or”, or both.

As used herein “(s)” following a noun means the plural and/or singular forms of the noun.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’ or ‘configured’ for the purpose that is stated.

Unless stated otherwise, the word ‘wire’ as is to be interpreted to mean a wire, a cable or a rope.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE DRAWINGS

The invention will now be described by way of example only and with reference to the drawings in which:

FIG. 1: shows a perspective view of a wire adjustment plate according to one embodiment of the present invention.

FIG. 2: shows the front view of the wire adjustment plate of FIG. 1.

FIG. 3: shows the rear view of the wire adjustment plate of FIG. 1.

FIG. 4: shows a side view of the wire adjustment plate of FIG. 1.

FIG. 5: shows a front view of a support system such as an earthquake bracing system or a support hanger system according to one embodiment of the present invention comprising a wire adjustment plate of FIG. 1 that is used with a wire to form the support system for supporting the item by bracing, suspending and/or holding at least one item.

FIG. 6: shows a side view of the support system of FIG. 5.

FIG. 7: shows a rear view of the support system of FIG. 5.

FIGS. 8A-8C: sequentially show a method using a wire adjustment plate of FIG. 1 for supporting at least one item by bracing, suspending and/or holding the item(s) using a wire. It can also be said that these Figures sequentially show a method of using a support system of FIG. 5 for supporting at least one item by suspending, bracing, and/or holding the item(s).

FIG. 8D: is a cross sectional schematic side view of FIG. 6 showing five of the seven points of contact between the wire and the wire adjustment plate of FIG. 1.

FIG. 9: shows a method using a wire adjustment plate of FIG. 1 for supporting at least one item by bracing, suspending and/or holding the item(s) using the wire. It can also be said that this Figure shows a method of using a support system of FIG. 5 for supporting at least one item by bracing, suspending and/or holding the item(s).

FIG. 10: shows an example of the support system of FIG. 5 when used in supporting an item by suspending, bracing and/or holding the item.

FIG. 11: is a graphical analysis showing a relationship between the hole diameter and wire diameter in the support system of FIG. 5.

FIG. 12: is a graphical analysis showing a relationship between the optimal dimensions of the wire adjustment plate of FIG. 1 and the diameter of a wire used with the wire adjustment plate of FIG. 1. It can also be said that FIG. 12 is a graphical analysis showing a relationship between the optimal dimensions of the support and the diameter of the wire used with the support system of FIG. 5.

FIGS. 13A-C: show another example of using the support system of FIG. 5 for supporting at least one item by bracing suspending and/or holding the item(s).

FIGS. 14A-N: show some examples of wire adjustment plates according to the present invention.

FIG. 15A: shows the wire adjustment plate of FIG. 1 that is deformed slightly under load.

FIG. 15B: shows the top view of the wire adjustment plate of FIG. 15A.

FIG. 16: shows a support system such as an earthquake bracing system or a support hanger system according to one embodiment of the present invention comprising a wire adjustment plate of FIG. 1 that is used with a wire to form the support system for supporting the item by bracing, suspending and/or holding at least one item.

### DETAILED DESCRIPTION OF THE INVENTION

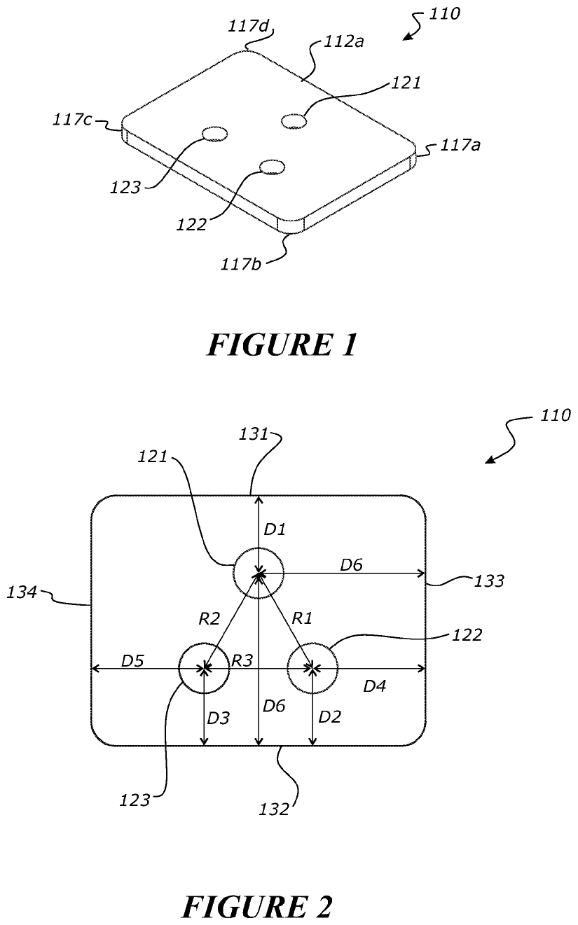

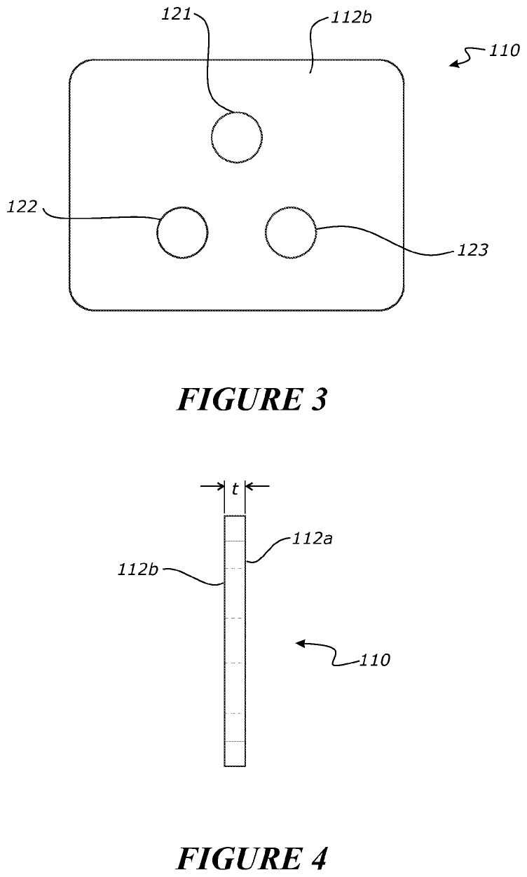

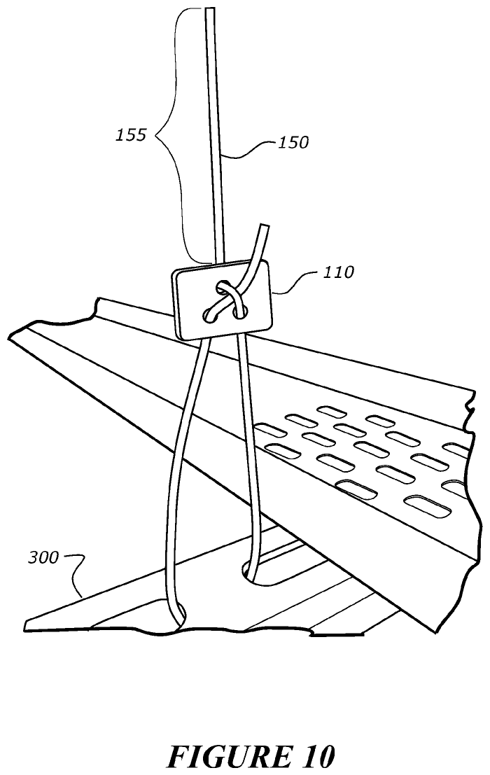

FIGS. 1-4 show a wire adjustment plate 110 that is configured to be used with a wire 150 in supporting an item by bracing, suspending and/or holding the item that may exert a load on the wire 150. The item 300 may be an object such as but not limited to a building material or a construction material, e.g. a beam of a framework as shown in FIG. 10. Although, FIG. 10 shows only one item 300, more than one item may be supported by bracing, suspending and/or holding by the wire 150. Other non-limiting examples of the item may include a pipe or a duct. Typically, the item may be an object that typically weighs above 1 kg and up to 300 kg for a vertical support. Most preferably, the item(s) may weigh between 25 kg and 100 kg. In some embodiments, the item may weigh 360 kg. In some embodiments, the item may weigh 475 kg. In some embodiments, the item may weigh between 300 kg to 500 kg. Seismic wire restraints may have no load exerted on them until there is a seismic event. In seismic wire restraints, the only load that is exerted may be the tension on the wire which may be done up hand tight. The wire adjustment plate 110 is in a form of (formed as) a single piece plate as shown in FIGS. 1-4. The wire adjustment plate 110 may be re-usable. In one embodiment, the wire adjustment plate 110 is a re-usable cleat.

At a planar surface 112a (first face side/front face side) of the wire adjustment plate 110 at least three see-through holes are formed, i.e. defined. In the embodiments shown, a total of three holes (eyelets) are defined. Those three holes as a first hole 121, a second hole 122 and a third hole 123. Each hole 121, 122, 123 are positioned, sized and shaped (i.e. suitably positioned/oriented, sized and shaped) to allow the wire 150 to pass through each hole (i.e. pass through the plate at each hole) for supporting the item 300 by bracing, holding and/or suspending the item 300 with equal distribution of force from the item 300 on the plate 110 at each of the holes 121, 122, 123. In use, the first hole 121 is located above the second and third holes 122, 123 with distances between the first hole 121 and the second hole 122 and the first hole 122 and the third hole 123 is the same. Since the distances between the first hole 121 and the second hole 122 and the first hole 122 and the third hole 123 are the same, it can be appreciated that distance R1 between the centre point of the first hole 121 and the centre point of the second hole 122 is same as the distance R2 between the centre point of the first hole 122 and the centre point of the third hole 123. The wire may be a load bearing wire. The force on the plate at each hole is from a load may be exerted on the wire by the item 300.

The holes 121, 122, 123 may be in symmetry (in perfect symmetry) so that equal force is applied to the plate at each hole. Such equal force may be applied by a load exerted on the wire 150 by the item 300. So, the distances between the first hole and the second hole, the first hole and the third hole, and the second hole and the third hole may be the same. In other words, the distance R1 between the centre point of the first hole and the centre point of the second hole, the distance R2 between the centre point of the first hole 121 and the centre point of the third hole 123, and distance R3 between the centre point of the second hole 122 and the centre point of the third hole 123 may be the same.

In some embodiments, the distance between the second hole 122 and third hole 123 may be very slightly different than the distance between the first hole 121 and the second hole 122 (and distance between the first hole 122 and the third hole 123) but only to an extent that the ability/advantages of supporting the item by bracing, holding and/or suspending the item(s) with equal distribution of force on the plate at each hole is not compromised. Since the first hole 121 is located above the second and third holes 122, 123 with distances between the first hole 121 and the second hole 122 and the first hole 122 and the third hole 123 being the same, equal distribution of force is still possible with such very slight differences in distance between the holes.

So, the holes 121, 122, 123 may be positioned to form/present a triangular (preferably equilateral triangle) pattern together.

The holes 121, 122, 123 may be of the same size. The holes 121, 122, 123 may be of the same shape. The suitable shape and size of holes can be important to ensure that there are two points of contacts between the wire 150 and the wire adjustment plate 110 at each of the holes 121, 122, 123. This together with orientation/positioning of holes 121, 122, 123 can also be important for uniform load/force distribution on the plate at each hole during use.

The holes 121, 122, 123 may be circular/round in shape as shown. The diameter of each of the holes 121, 122, 123 may be above 1 mm and below 11 mm. The portion of plate 110 defining the holes 121, 122, 123 may be hollow cylindrical due to the thickness t of the plate. Preferably the holes define the cylindrical shape with the axis of the cylinder being parallel a notional normal of the plane of the plate.

In some embodiments, the diameter of each hole is above 1 mm and below 7 mm. In some embodiments, the diameter of each hole is above 1 mm and below 5 mm. In some embodiments, the diameter of each hole is above 1 mm. In some embodiments, In some embodiments, the diameter of each hole is or is about 2 mm or 3 mm. In some embodiments, the diameter of each hole is or is about 4 mm. In some embodiments, the diameter of each hole is or is about 4 mm for a wire of diameter between 1 mm to 1.6 mm to pass through. In some embodiments, the diameter of each hole is or is about 5 mm. In some embodiments, the diameter of each hole is or is about 5 mm for a wire of diameter between 2 mm to 2.4 mm to pass through. In some embodiments, the diameter of each hole is or is about 6 mm. In some embodiments, the diameter of each hole is or is about 6 mm for a wire of diameter between 3 mm to 3.2 mm to pass through. In some embodiments, the diameter of each hole is or is about 8 mm. In some embodiments, the diameter of each hole is or is about 8 mm for a wire of diameter between 4 mm to 5 mm to pass through. In some embodiments, the diameter of each hole is or is about 10 mm. In some embodiments, the diameter of each hole is or is about 10 mm for a wire of diameter between 6 mm to 6.3 mm to pass through.

The wire adjustment plate 110 may of sufficient thickness so that it is strong enough not to break and/or significantly deform during use. Preferably the plate does not in-elastically yield. Also, it is desirable that plate 110 is not unnecessarily too thick and large in volume. The wire adjustment plate 110, i.e. the plate, may be of uniform/constant thickness, e.g. the wire adjustment plate 110 may be or may be about 2 mm, 3.5 mm or 5 mm in thickness. In some embodiments the wire adjustment plate 110 may be of non-uniform/variable thickness. For example, in some embodiment, the wire adjustment plate 110 may be or may be about 3.5 mm in thickness at a top portion and may be or may be about 3.4 mm in thickness at a bottom portion. Similarly, in some embodiment, the plate may be or may be about 5 mm in thickness at a top portion and may be or may be about 4.1 mm in thickness at a bottom portion.

As shown in FIGS. 1-3, the wire adjustment plate 110 may be a substantially rectangular plate having a first side 131 (first edge 131), a second side 132 (second edge 132), a third side 133 (third edge 133) and a fourth side (fourth edge 134). The first side 131 and second side 132 may be located opposite to one another and the third side 133 and the fourth side 134 may be located opposite to one another. The first hole 131 may be located more proximal to the first side 131 than the second hole 122. The second hole 122 may be located more proximal to the second side 132 than the first hole 121. The second hole 122 may be located more proximal to the third side 133 than the third hole 122. The third hole 123 may be located more proximal to the fourth side 134 than the second hole 122. Similarly, the second hole 122 may be located more proximal to the third side 133 than the first hole 121. The third hole 123 may be located more proximal to the fourth side 134 than the first hole 121.

As shown in FIG. 1, each corner 117a, 117b, 117c, 117d of the wire adjustment plate 110 (i.e. plate 110) may be rounded so that the corners are not sharp as sharp corners can cause injury (for example during seismic events). The rounded corners also make it easy to grasp the plate and/or adjust the plate and/or adjust the wire that engages with plate. Further, the rounded corners are also more aesthetically pleasing than sharp corners.

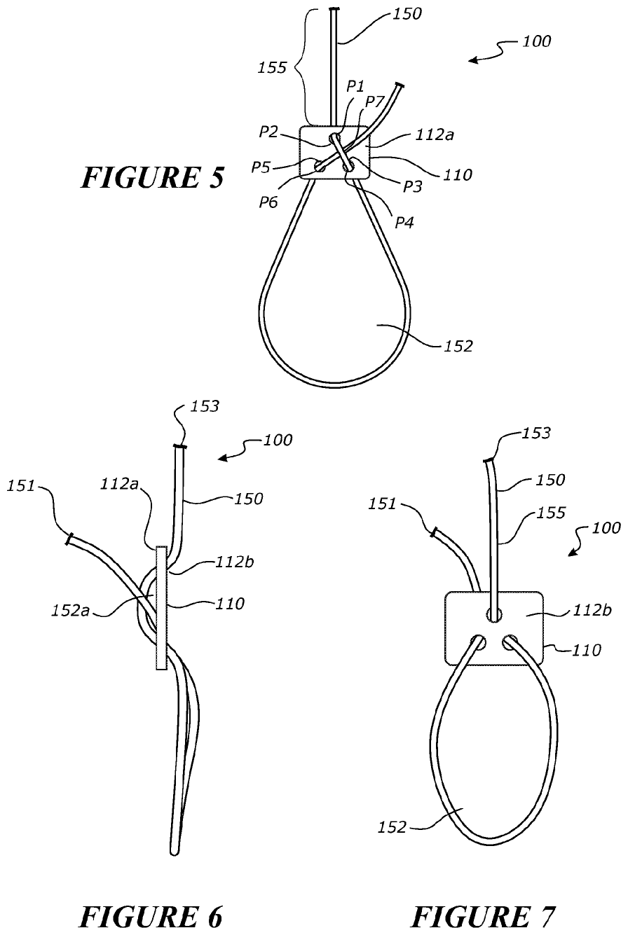

As shown in FIG. 5, the holes 121, 122, 123 may be in perfect symmetry so that when the item 300 is added as shown in FIG. 10, equal forces is applied on the plate at each hole 121, 122, 123 keeping the point loading in line with a vertical portion 155 of the wire 150. The vertical portion of the wire 155 may be the portion that may be proximal to the external body such a but not limited to a ceiling of a building when the support system 100 suspends from such external body. The support system 100 may be an earthquake bracing system which is often referred to in the industry as often referred to as seismic restraint, seismic bracing or an earthquake protection system. In some embodiments, the support system may be a support hanger system. As shown, the support system 100 attaches/couples to the item 300 to support by bracing, suspending and/or holding the item 300.

The hole spacing can be important as that can allow for the wire 150 to perform a loop 152 (e.g. suspension loop 152) leaving a gap 152a of approximately a quarter of the size of the wire diameter thereby creating a clamping force when the loose end 151 of the wire 150 passes through the gap 152a. The three holes 221, 122, 123 in the wire adjustment plate 110 offsets the load and forces the wire 120 on an unnatural course with loose end 151 of the wire 150 looping underneath the main wire 152a. When load is exerted on the wire by the item 300, the main wire 150 tries to return to its natural state, therefore, pulling down on the vertical portion 155 (tail end) of the wire thereby allowing a portion 158 of the wire to be clamped in place.

The distance between the first hole 121 and the first side 131 may be the same as the distance between the second hole 122 and the second side 132. So, in FIG. 2, the distance D1 between the centre of the first hole 121 and the first side 131 may be the same as the distance between the centre of the second hole 132 and the second side 132.

The distance between the first hole 121 and the first side 131 may be the same as the distance between the third hole 133 and the second side 132. So, in FIG. 2, the distance D1 between the centre of the first hole 121 and the first side 131 may be the same as the distance D3 between the centre of the third hole 133 and the second side 132.

Similarly, the distance between the second hole and the third side may be the same as the distance between the third hole and the fourth side. So, in FIG. 2, the distance D4 between the centre of the second hole 122 and the third side 133 may be the same as the distance D5 between the centre of the third hole 123 and the fourth side 134.

The distance between the first hole 121 and the first side 131 may be the same as the distance between the second hole 122 and the third side 133. So, in FIG. 2, the distance D1 between the centre of the first hole 121 and the first side 131 may be the same as the distance D4 between the centre of the second hole 122 and the third side 133.

The distance between the first hole 121 and the first side 131 may be the same as the distance between the third hole 133 and the fourth side 134. So, in FIG. 2, the distance D1 between the centre of the first hole 121 and the first side 131 may be the same as the distance D5 between the centre of the third hole 133 and the fourth side 134.

As mentioned above, such hole spacing can be important as that can allow for the wire 150 to perform a loop 152 leaving a gap 152a of approximately a quarter of the size of the wire diameter thereby creating a clamping force when the loose end 151 of the wire 150 passes through the gap 152a.

Each of the first side 131 and the second side 132 may be between 30 mm and 80 mm in length. The distance between the centre point of one hole to the centre point of another hole may be between 7 mm to 23 mm. In one embodiment, the distance between the centre point of one hole to centre point of another hole may be or may be about 8.6 mm. In one embodiment, the distance between the centre point of one hole to the centre point of another hole may be or may be about 10.7 mm.

In one embodiment, each of the first side and the second side is or is about 40 mm and each of the third side and the fourth side is or is about 30 mm in length. The distance D4 between the centre point of second hole 122 to the third side 133 may be or may be about 13.5 mm. The distance D5 between the centre point of the third hole 123 to the fourth side 134 may be or may be about 13.5 mm. The distance D6 between the centre point of first hole 121 to the second side 132 may be or may be about 20.7 mm. The distance D1 between the centre point of first hole 121 to the first side 131 may be or may be about 9.3 mm. The distance D2 may be same as distance D3, the distance D4 may be the same as distance D5 and the distance D1 may be the same as distance D2, D3, D4 or D5. The diameter of each hole may be 6 mm for a wire of about 3 mm to 3.2 mm to pass through. The thickness of the plate may be or may be about 2.5 mm. The distance between centre point of one hole to centre point of another hole may be about 13.12 mm. For example, distance R1 between the centre point of the first hole 121 to the centre point of the second hole 122 is or is about 13.12 mm and the distance R3 between the centre point of the second hole 122 to the centre point of the third hole 123 is or is about 13 mm. Distance R1 may be the same as distance R2.

In one embodiment, each of the first side and the second side may be or may be about 53 mm in length. Similarly, each of the third side and fourth side may be or may be about 39.8 mm in length. The distance D4 between centre point of second hole 122 to the third side 133 may be or may be about 17.9 mm. The distance D5 between the centre point of the third hole 123 to the fourth side 134 may be or about 17.9 mm. The distance D6 between the centre point of first hole 121 to the second side 132 may be or may be about 12.3 mm. The distance D1 between the centre point of first hole 121 to the first side 131 may be or may be about 12.3 mm. The distance D2 may be the same as distance D3, the distance D4 may be same as distance D5 and the distance D1 may be same as distance D2, D3, D4 or D5. The diameter of each hole may be 8 mm for a wire of about 4 mm to 5 mm to pass through. The thickness of the plate may be or may be about 3.5 mm. The thickness may or may not be uniform. For example, the thickness may be about 3.5 mm at or near the top portion and 3.4 mm at or near the bottom portion. The distance between the centre point of one hole to the centre point of another hole may be or may be about 17.4 mm. For example, the distance R1 between the centre point of the first hole 121 to the centre point of the second hole 122 may be or may be about 17.4 mm and distance R3 between the centre point of the second hole 122 to the centre point of the third hole 123 may be or may be about 17.2 mm. Distance R1 may be the same as distance R2.

In one embodiment, each of the first side and the second side may be or may be about 67 mm. Similarly, each of the third side and the fourth side may be or may be about 50.2 mm. The distance D4 between the centre point of second hole 122 to the third side 133 may be or may be about 22.65 mm. The distance D5 between the centre point of the third hole 123 to the fourth side 134 may be or may be about 22.65 mm. The distance D6 between the centre point of the first hole 121 to the second side 132 may be or may be about 15.6 mm. The distance D1 between the centre point of the first hole 121 to the first side 131 is or is about 15.6 mm. The distance D2 may be the same as distance D3, the distance D4 may be the same as distance D5 and the distance D1 may be the same as distance D2, D3, D4 or D5. The diameter of each hole may be 10 mm for a wire of about 6.0 mm to 6 mm to pass through. The thickness of the plate may be or may be about 5 mm. The thickness may or may not be uniform. For example, the thickness may be about 5.0 mm at or near the top portion and 4.1 mm at or near the bottom portion. The distance between the centre point of one hole to the centre point of another hole may be or may be about 22 mm. The distance R1 between the centre point of the first hole 121 to the centre point of the second hole 122 may be or about 22 mm and the distance R3 between the centre point of the second hole 122 to the centre point of the third hole 133 may be or may be about 21.7 mm. Distance R1 may be the same as distance R2.

The wire adjustment plate 110 needs to be constructed of a suitable material to withstand the load exerted by the item 300. In one embodiment, the plate is a metallic plate. In one embodiment, the plate is resistant to corrosion so that is can be used even in a corrosive environment. The wire adjustment plate 110 may be made out of or may comprise stainless steel. The wire adjustment plate 110 may be made out of or may comprise a galvanized metal. The wire adjustment plate 110 may have a zinc-plated finish. The wire adjustment plate 110 may be a 2.5 mm cold rolled Gr300 mild steel plate. The wire adjustment plate 110 may be made out of or may comprise a hot-dip galvanized metal.

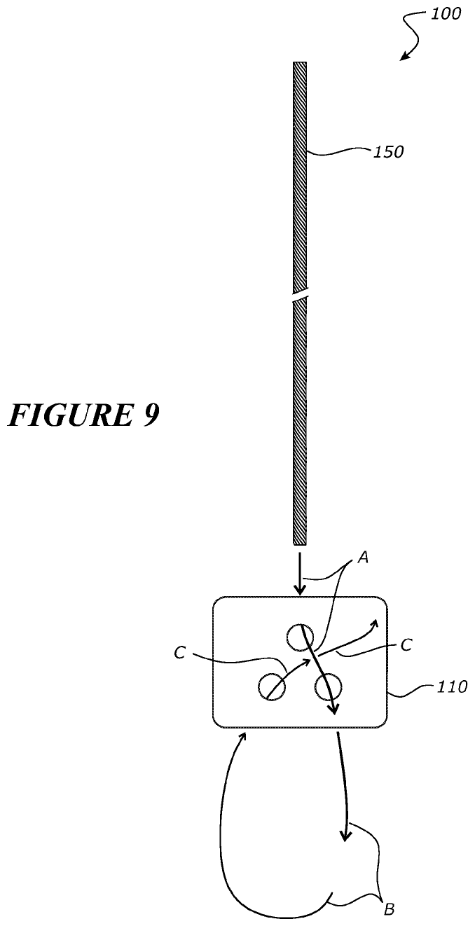

The wire 150 may be made of a material that allows a portion of the wire to clamp between another portion of the wire and the wire adjustment plate with a clamping force that facilitates supporting item 300 by bracing, holding and/or suspending of the item 300 and/or to further facilitate two points of contact between the wire and the plate at each hole during use. This eliminates any need for an external tool for clamping the wire 150 to secure the item. This helps reduce the crimping of the wire 150. The wire 150 may be a steel core wire. The wire 150 may be a stainless-steel wire. The wire 150 may be an Aircraft cable or a pre-stretched Aircraft cable as shown in FIG. 9. The wire 150 may be a 7×7 or 7×19 (steel Core) stainless steel wire rope. The wire 150 may be a constructed wire. The wire 150 may be a stretchable wire. The wire 150 may be of a suitable diameter to further facilitate two points of contact between the wire 150 and the plate 110 at each hole. The diameter of the wire may be as described above.

As mentioned above, the wire adjustment plate 110 and/or wire 150 may be made from metallic materials thereby providing a better fire resistance/retardant. This is advantageous over products made out of or comprising non-metallic materials (e.g. plastic) which can be easily damaged by fire. By being made out of metallic materials, the present invention when used in seismic bracing and/or as a suspension hanger is also advantageous over suspension hangers and seismic brace products having small parts inside lock casing such as wedges, small steel springs, pins etc that could easily be damaged by fire.

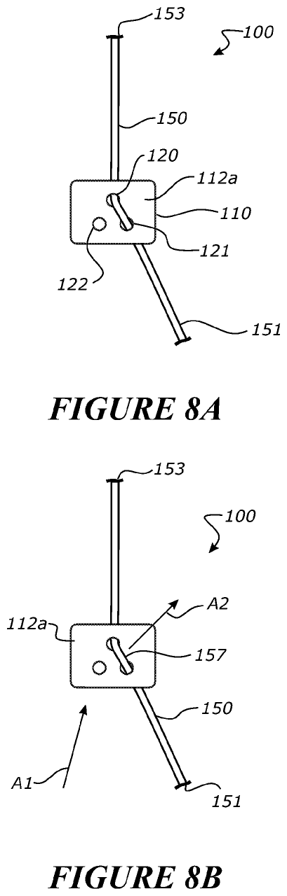

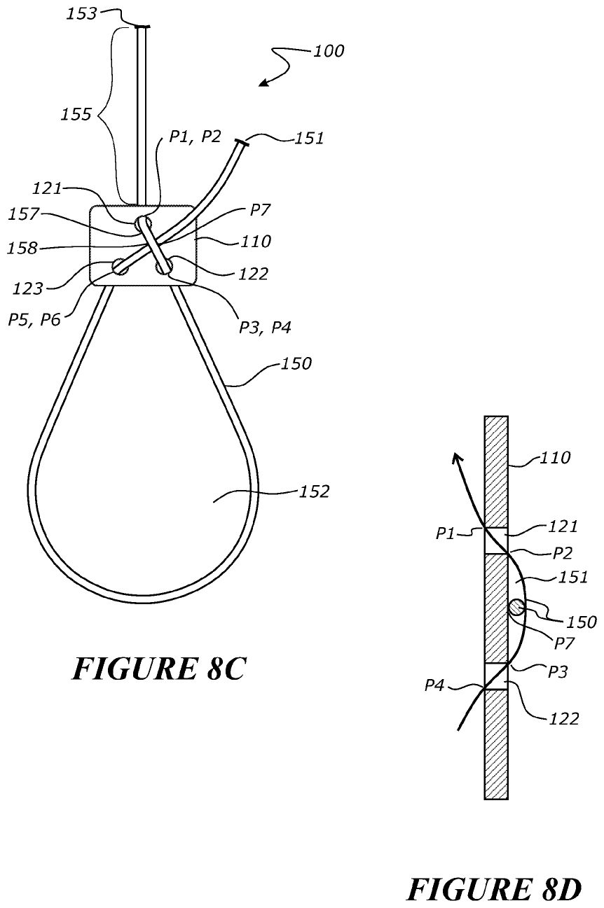

The wire 150 may be adapted to pass through the plate at each hole 121, 122, 123 so that the wire 150 forms a loop 152 for supporting the item 300 by holding and/or suspending the item 300 with at least seven points of contact P1, P2, P3, P4, P5, P6 between the wire and the plate with two points of contact per hole and the seventh point of contact P7 between the wire and the wire adjustment plate. As shown in FIGS. 5 and 8D, there may be two points of contacts P1, P2 between the wire and the plate at the first hole 121, two points of contact P3, P4 at the second hole 122 and two-points P5, P6 of contacts at the third hole 123. The seventh point of contact P7 may be located between a portion 158 of the wire and a portion of the wire adjustment plate (first face side 112a which is a planar surface).

Having only seven points of contact with equal points of contact(2 points of contact) between the wire 150 and the plate 110 at each hole allows equal force to be applied on the plate at each hole keeping the point loading in-line with the vertical portion 155 of the wire during use. Also, this forces the wire 150 from its natural state creating a dog-leg in the wire 150 at each hole acting like a clamp and forcing the wire 150 into the two sharp opposing edges of each hole. The clamping force is increased as more load is applied to the wire 150. The greater the load that is exerted, the greater the clamping force.

Having equal points of contact(2 points of contact) between the wire 150 and the plate 110 at each hole also allows the plate to be held at the set height (or distance) on the main single wire, until loosened and manually adjusted.

Another advantage of having equal points of contact (2 points of contact) between the wire 150 and the plate 110 at each hole would be that the plate 110 will be forced to sit parallel with the main single wire. Both edges of holes will work against each other on the wire 150 forcing the wire 150 and plate 110 to become parallel to one another. This is both functionally and aesthetically pleasing.

Having each hole as rounded or circular hole, as shown, is advantageous as such a hole properly seats/captures the wire 150 and gives it more footprint/coverage to clamp the wire 150, at the same time reducing the point load strain on the wire 150 and the plate 110 (compared to a square hole with straight edge).

The wire may be circular in cross section. The wire may be circular in cross section in an axis that is orthogonal to its length when in fully stretched condition. The round wire is also subject to slightly deforming under load when pushed against an edge of each hole. The rounded hole reduces the deforming and retains the original wire diameter/strength/shape best, therefore increases the effectiveness of the clamp.

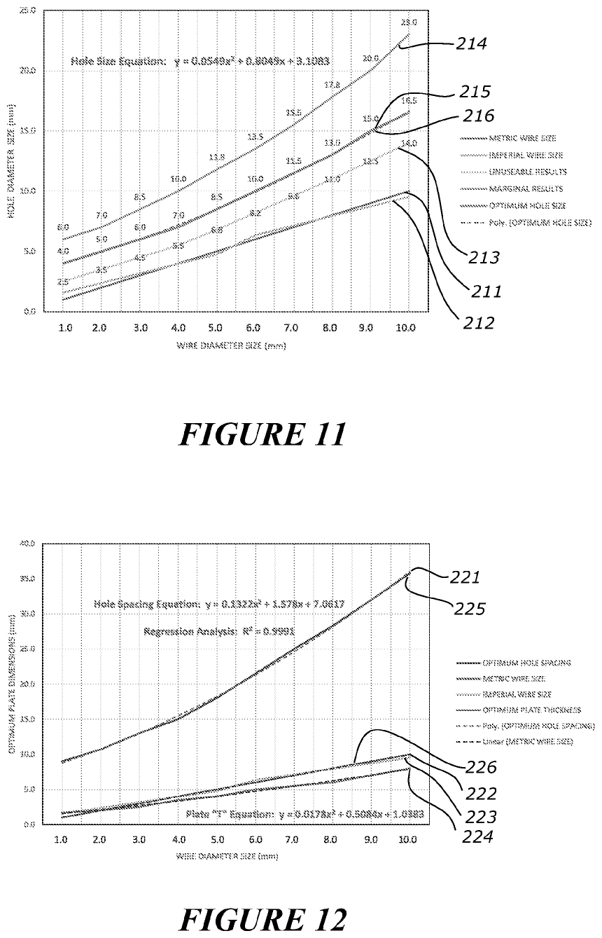

FIG. 11 is a graphical analysis showing a relationship between the diameter of the hole and the diameter in the support system 100 of FIG. 5 comprising the wire adjustment plate 110 and wire 150 as described above. Tables 1 and 2 below show the data relating to the graphical analysis of FIG. 11.

TABLE 1

| WIRE SIZE (mm) | 1.0 | 2.0 | 3.0 | 4.0 | 5.0 | 6.0 | 7.0 | 8.0 | 9.0 | 10.0 |
|---|---|---|---|---|---|---|---|---|---|---|
| HOLE SIZE | 6.0 | 7.0 | 8.5 | 10.0 | 11.8 | 13.5 | 15.5 | 17.8 | 20.0 | 23.0 |
| MARGINAL | | | | | | | | | | |
| RESULTS (mm) | | | | | | | | | | |
| OPTIMUM HOLE | 4.0 | 5.0 | 6.0 | 7.0 | 8.5 | 10.0 | 11.5 | 13.0 | 15.0 | 16.5 |
| SIZE (mm) | | | | | | | | | | |
| HOLE SIZE | 2.5 | 3.5 | 4.5 | 5.5 | 6.8 | 8.2 | 9.6 | 11.0 | 12.5 | 14.0 |
| UNUSEABLE | | | | | | | | | | |
| RESULTS (mm) | | | | | | | | | | |

TABLE 2

| | WIRE SIZE (Inch) | | | | | | | | | |
|---|---|---|---|---|---|---|---|---|---|---|
| | 1/16″ | 3/32″ | ⅛″ | 5/32″ | 3/16″ | ¼″ | 9/32″ | 5/16″ | 11/32 | ⅜″ |
| | 1.59 | 2.38 | 3.18 | 3.97 | 4.75 | 6.35 | 7.14 | 7.94 | 8.73 | 9.53 |
| HOLE SIZE | 6.0 | 7.0 | 8.5 | 10.0 | 11.8 | 13.5 | 15.5 | 17.8 | 20.0 | 23.0 |
| MARGINAL | | | | | | | | | | |
| RESULTS (mm) | | | | | | | | | | |
| HOLE SIZE | 4.0 | 5.0 | 6.0 | 7.0 | 8.5 | 10.0 | 11.5 | 13.0 | 15.0 | 16.5 |
| OPTIMAL (mm) | | | | | | | | | | |
| HOLE SIZE | 2.5 | 3.5 | 4.5 | 6.0 | 6.8 | 8.2 | 9.6 | 11.0 | 12.5 | 14.0 |
| UNUSEABLE | | | | | | | | | | |
| RESULTS (mm) | | | | | | | | | | |

In FIG. 11, plot 111 shows wire size (in metric), plot 212 shows wire size (in imperial), plot 213 shows unusable results, plot 214 shows marginal results, plot 215 shows optimum hole size and plot 216 is a linear plot of the optimum hole size.

In FIG. 11, plot 214 shows that the hole size is too big for the wire. Plot 213 shows that the hole size is too small for the wire. Plot 216 shown by a dashed line is a working zone.

FIG. 12 is a graphical analysis showing a relationship between the optimal dimensions of the wire adjustment plate and the diameter of the wire used with the support system of FIG. 5 comprising the wire adjustment plate 110 and wire 150 as described above. Plot 221 is the optimal hole spacing, plot 222 shows a hole size (in metric), plot 223 shows a hole size (in imperial), plot 224 shows optimal plate thickness, plot 225 shows optimal hole spacing and plot 225 shows linear metric hole size.

Tables 3 and 4 below show the data relating to the graphical analysis of FIG. 12.

TABLE 3

| WIRE SIZE (mm) | 1.0 | 2.0 | 3.0 | 4.0 | 5.0 | 6.0 | 7.0 | 8.0 | 9.0 | 10.0 |
|---|---|---|---|---|---|---|---|---|---|---|
| OPTIMUM HOLE | 9.0 | 10.7 | 13.0 | 15.0 | 18.0 | 21.5 | 25.0 | 28.3 | 32.0 | 35.8 |
| SPACING | | | | | | | | | | |
| CENTRES (mm) | | | | | | | | | | |
| OPTIMUM | 1.7 | 2.0 | 2.5 | 3.5 | 4.0 | 5.0 | 5.5 | 6.0 | 7.0 | 8.0 |
| PLATE | | | | | | | | | | |
| THICKNESS (mm) | | | | | | | | | | |

TABLE 4

| WIRE SIZE (mm) | 1.0 | 2.0 | 3.0 | 4.0 | 5.0 | 6.0 | 7.0 | 8.0 | 9.0 | 10.0 |
|---|---|---|---|---|---|---|---|---|---|---|
| SAFE WORKING | 50 | 100 | 200 | 250 | 300 | 400 | NA | 500 | NA | 750 |
| LOAD RATING (kg) | | | | | | | | | | |

If the holes 121, 122, 123 are too small for the wire 150, then that may not provide the desired functionality, or at least the optimum desired functionality. Similarly, if the holes 121, 122, 123 are too big for the wire then 150 clamping may become less effective to the point where it may not provide its desired functionality or at least the optimum desired functionality. The larger the size of the holes 121, 122, 123, the larger the plate 110 that may be needed to achieve the desired functionality or at least the optimum desired functionality. This can make the plate 110 more costly and more out of proportion and therefore it may not be cost effective nor visually/aesthetically appealing.

The graph to FIGS. 11 and 12 demonstrate the workable zone and have assisted in determining the optimum sizing of each of the holes 121, 122, 123, optimum hole spacing and optimum sizing of the plate 110 which may work practically and functionally at optimum.

In the graphs of FIGS. 11 and 12, the wire size lines 212, 213, 223 and 226 are shown as reference lines. From FIGS. 11 and 12, it can be appreciated that wire size lines 212, 213, 223 and 226 the relationship between y and x may be:

y=x (1)
where, x is the wire diameter size and y is the variable.

For the graph of FIG. 11, for the hole size, the x and y relationship may be:

y=0.0549x²+0.8049x+3.1083 (2)
where, x is the wire diameter size and y is the variable.

For the graph of FIG. 12, for the hole size, the x and y relationship may be:

y=0.1322x²+1.578x+7.0617 (3)
where, x is the wire diameter size and y is the variable.

For the graph of FIG. 12, for the plate thickness (t), the x and y relationship may be:

y=0.0178x²+0.5084x+1.0383 (4)
where, x is the wire diameter size and y is the variable.

FIGS. 8A-8C and 9 show a method of using a wire adjustment plate 110 (or an support system 100) for supporting an item 300 by bracing, suspending and/or holding the item 300 as shown in FIG. 10. As previously mentioned, although FIG. 10 shows one item, more than one item may be supported by bracing, suspending and/or holding the item.

In the method shown, the wire adjustment plate 110 and a wire 150 as described above are provided. The wire 150 is passed through each hole (i.e. through the plate 110 at each hole) so that the wire 150 supports by holding, bracing and/or suspending the item 300 with equal distribution of force on the plate 110 at each hole 121, 122, 123. A portion 157 of the wire 158 is allowed to clamp between another portion 157 of the wire and the wire adjustment plate 110 with a clamping force that facilitates supporting the item by bracing, holding and/or suspending of the item.

As shown, the method comprises passing the wire 150 through each hole 121,122, 123 so that the wire 150 forms a loop 152 (preferably for supporting item by bracing, holding and/or suspending the item with at least six points of contact P1-P7 between the wire and the plate 110 with two points of contact per hole (i.e. two points of contact at each hole) as described above.

The forming of the loop the following steps may be performed in sequential order as shown in FIGS. 8A-8C and 9. In order to form loop 152 a loose end 151 of the wire 155 may be passed through a first hole 122 from a rear face side 112b of the plate 110 towards a front face side 112a of the plate 110. The loose end 151 of the wire 150 may then be passed through the second hole 122 from the front face side 112a towards the rear face side 112b. This is shown in FIG. 8A. As shown by the arrows A1, A2 in FIG. 8B, the loose end 151 of the wire 150 may then be passed through the third hole 133 from the rear face side 112n towards the front face side 112a.

As shown in FIGS. 8B and 8C and 9, after the loose end 151 of the wire is passed through the third hole 123 from the rear face side 123 towards the front face side 112a, the loose end 151 may be passed through the underneath (i.e. through the gap 152a) of an exposed portion 157 of wire that extends between the first hole 121 and the second hole 122 at the front face side 112a to cause a portion 158 of the wire 155 located underneath said exposed portion to be clamped between the exposed portion 157 and the front face side 112a. The loose end 151 may be pulled further in the direction of arrow A2 to decrease the size of the loop and/or to increase the height of the item 300 from the group. Similarly, loose end 151 may be pushed in a direction opposite the arrow A2 so as cause increase the size of the loop and/or to decrease the height of the item 300 from the ground.

FIG. 9 shows the method as described above with arrows A, B and C showing how the wire may be allowed to pass through the holes to form the loop 152 and perform the clamping action as described above. It is apparent that A, B and C are performed in sequential order. The wire 150 in FIG. 9 is shown as an Aircraft cable.

In order to dislodge the item 300 secured within the loop, the loose end 151 of the wire 150 may be pushed in a direction opposite the arrow A2 of FIG. 8B so as disengage the wire from the third hole when will then open the loop 152. The wire 150 then be pulled out from the second hole 122 and the first hole 121.

It can therefore be appreciated that the method order to dislodge the item 300 secured within the loop or to open the loop 152 can be reverse of the method of creating the loop 152 as described above.

The loose end 151 of the wire 150 may be looped around at least a portion of the item 300 for supporting item by bracing, suspending and/or holding the item 300 prior to passing the loose end of the wire through the third hole 123 from the rear face side 112b towards the front face side 112a.

In one embodiment, a portion 158 of the wire located underneath the exposed portion when clamped between said exposed portion 157 and the front face side 112a may be a clamped portion of the wire 150. The clamped portion forms the seventh point of contact P7 between the wire 150 and the wire adjustment plate 110. This is more clearly shown in FIG. 8D.

The clamping force may be higher than the force exerted by the item 300 to ensure that the item 300 is secured properly within the loop 152.

The second loose end 155 of the wire may be secured to an external body so that the wire adjustment plate 155 engages with or suspends from the external body. The external body may be a ceiling of a building.

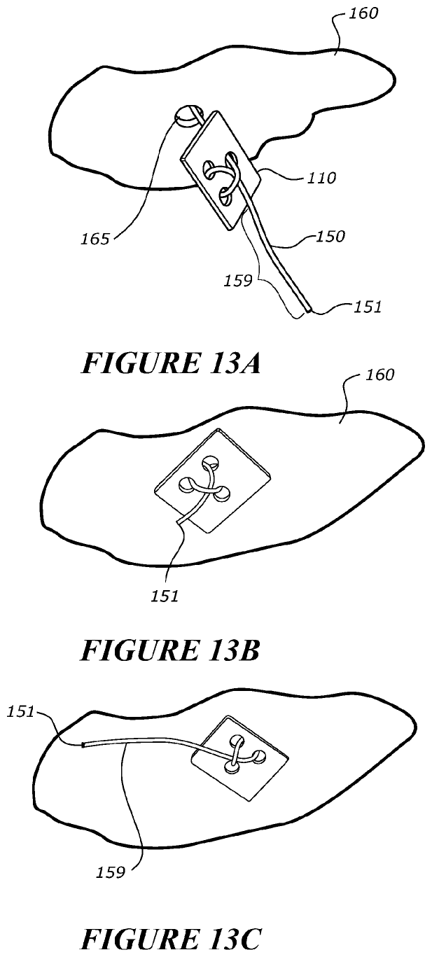

The support system 100 is can be used as a toggle support as shown in FIGS. 13A-13C. As shown in FIGS. 13A-13C the support system 100 may be attached to a ceiling 160 of a building. A cavity 165 may be drilled on the ceiling and the vertical portion 155 of the wire 150 may be secured to the ceiling.

The support system 100 with the loop 152 as described above may similarly be secured to the ceiling through a cavity 165 with a vertical portion 155 suspending from the ceiling.

In the example shown in FIGS. 13A-13C, the loop is smaller than loop 152 as described above. Here, the first end 151 is pulled thereby decreasing the size of the loop 152 further to engage the rear face side 112b to engage with the surface of the ceiling and the item may be supported by the suspension portion 159 of the wire 150 that is proximal to the loose end 151. However, suspending item at the suspension portion 159 is less preferred as it can require forming of a knot for securing the item appropriately.

From the above, it can be appreciated that in one embodiment, the present invention may reside in a re-usable cleat/plate 110 for use with a suspension cable capable of adjusting and setting the effective suspension distance between a structure and an object (item 300) to be suspended from and by said structure. The cleat/plate 110 comprises at least three see-through holes 121, 122, 123. Each hole are positioned, sized and shaped (suitably positioned, sized and shaped) to allow the wire to pass through each hole for suspending the item 300 with equal distribution of force on the cleat/plate 110 at each hole. The three holes are a first hole 121, a second hole 122 and a third hole 123. The first hole 121 are located when in use, above the second and third holes 122, 123 with distances between the first hole 121 and the second hole 122 and the first hole 121 and the third hole 123 being the same.

The effective suspension distance is able to be varied by the cleat/plate 110.

From the above, it can also be appreciated that, in one embodiment, the invention may reside in an overhead building structure comprising a ceiling 160 with a cavity 165 within which building material (item 300) is suspended from the structure by the support system 100 the support system 110.

It can be appreciated that use as a toggle support as shown in FIGS. 13A-13C does not only relate to a ceiling. Such toggle support can also act as a toggle washer for many items such as but not limited to lights, luminaries, pendants, signs, building services trapeze supports etc.

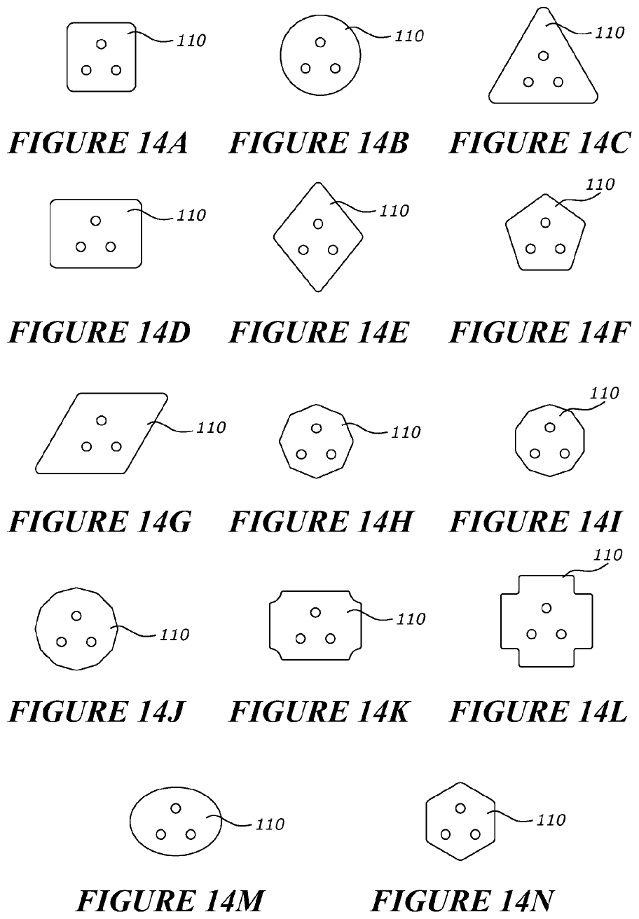

FIGS. 14A-N show examples of wire adjustment plate according to the present invention. More specifically, FIGS. 14A-N show some non-limiting examples of possible shapes of the plate 110. These are as follows:
a square shape (as shown in FIG. 14A)
a circular shape (as shown in FIG. 14B)
a triangular shape (as shown in FIG. 14C)
a rectangular shape (as shown in FIG. 14D)
a diamond shape (as shown in FIG. 14E)
a pentagonal shape (as shown in FIG. 14F)
a parallelogram shape (as shown in FIG. 14G)
an octagonal shape (as shown in FIG. 14H)
a decagonal shape (as shown in FIG. 14I)
a dodecagonal shape (as shown in FIG. 14J)
a plaque shape (as shown in FIG. 14K)
a cross shape (as shown in FIG. 14L)
an oval shape (as shown in FIG. 14M)
a hexagonal shape (as shown in FIG. 14N)

Apart from their shapes, the plates shown in FIGS. 14A to 14N may be same or substantially be same as the plate 110 described above with reference to FIGS. 1 to 13 and FIGS. 15A-B and 16 below, and therefore need not be described again.

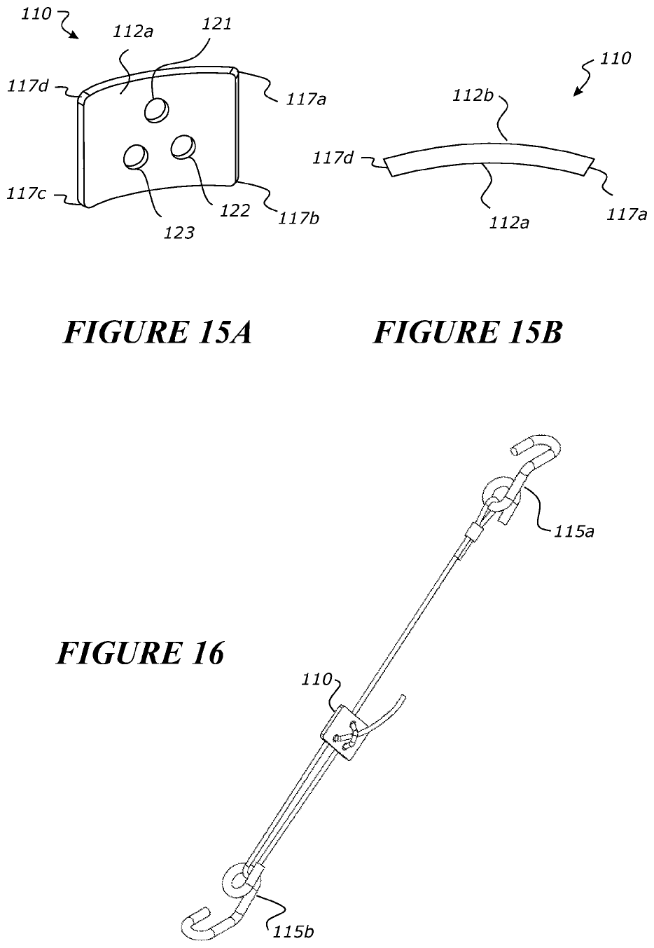

As shown in FIGS. 15A and 15B, the wire adjustment plate 110 may be deformable or bendable. The wire adjustment plate 110 may be made out of a malleable material to allow the wire adjustment plate to be deformed or bent when the force applied at each or at least one hole exceeds beyond a threshold amount of force. The wire adjustment plate 110 may be deformed or bent prior to failing or breaking. The threshold amount of force may be pre-determined.

By being able to be deformed or bent, the wire adjustment plate can provide good indication of any damage. When subjected to excessive loading (i.e., the high end of scale the seismic brace assembly is rated to), the wire adjustment plate 110 may deform (or slightly deform) under the load. At this point, the wire adjustment plate 110 does not fail, but provides a good indication that the whole assembly has been taken past its rated design limit and should be replaced. This allows for easy visual inspection by an engineer/inspector after a seismic event to determine whether the cable/wire braces can remain or need to be replaced. This can also provide advantages over seismic bracing systems or where the wire locking point is typically enclosed inside a casing with serrated wedges (which is usually the point of failure). In such seismic bracing systems or products where the wire locking point is typically enclosed inside a casing, there may be hidden wire fatigue or broken wire strands which are not easily visible and such wire fatigue or broken wire strands can severally reduce the load capacity or cause failure in the next seismic event.

FIG. 16 shows a support system such as an earthquake bracing system or a support hanger system according to one embodiment of the present invention comprising a wire adjustment plate of FIG. 1 with a wire to form the support system for supporting the item by bracing, suspending and/or holding at least one item. Support system of FIG. 16 is essentially the same as the support system 100 as described above and therefore most of the descriptions above relating to support system 100 equally applies to support system of FIG. 16 and therefore need not be described again. Hence, only the main differences will be discussed.

The differences between support system 100 and the support system of FIG. 16 can be determined by comparing FIG. 5 with FIG. 16.

As shown in FIG. 16, the support system may comprise at least one bracing member (in this example a hook) that is coupled to at least one loop formed by the wire at or proximal to one or each end of the support hanger system or the earthquake bracing system. As shown in FIG. 16, the support system may comprise two hooks 115a, 115b. The first hook 115a is coupled to a first loop formed by the wire at or proximal to a first end of the support system and a second hook 115b coupled to a second loop formed by the wire at or proximal to a second end (opposite the first end) of the support system. Although FIG. 16, shows two hooks 115a, 115b, one or more hooks may be replaced with any other suitable bracing members such as but not limited to brackets (e.g. 45 degree angle brackets).

Some non-limiting advantages of the present invention may include:
Load rated
Height adjustable
Can be used with various length of wire depending upon the application
Fast installation as no complex design
No tools required for use
Height adjustable
Need no moving parts
Low cost/cost-effective
Can be supplied in different finishes for various environments e.g Stainless Steel or Hot Dip Galvanized finish for corrosive environments
Can be Supplied for different wire rope sizes
Low risk of crimping of the wire as no separate clamping tools are required to be used
After being subjected to loading and returned back to normal state, plate 110 of the present invention can remain just as easy to adjust. Therefore, the applied load cannot cause the locking wedges to ‘bite’ harder into the wire 150. Therefore, the present invention can make it very easy to adjust the lock even when the load is large. There is no need to make the adjustment by tightening the assembly more to allow the wire to pass over the wedge/bite deformation.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention as described and/or claimed in this specification.

1. A wire adjustment plate to be used together with a wire in supporting at least one item by bracing, suspending and/or holding the at least one item, the wire adjustment plate being in a form of a single piece plate at a planar surface of which at least three see-through holes are provided, each hole being positioned, sized and shaped to allow the wire to pass through each hole for supporting the at least one item by bracing, suspending and/or holding the at least one item with equal distribution of force at each hole,
wherein the at least three holes are a first hole, a second hole and a third hole, the first hole being located, above the second and third holes with distances between the first hole and the second hole and the first hole and the third hole being the same.

2. The wire adjustment plate as claimed in claim 1,
wherein each hole is positioned, sized and shaped to allow the wire to pass through each hole so that the wire forms a loop for supporting the at least one item by bracing, holding and/or suspending the at least one item with at least six points of contact between the wire and the plate with two points of contact of the wire with the plate at each hole.

3. The wire adjustment plate as claimed in claim 1, wherein the at least three holes are in symmetry so that equal force is applied on the plate at each hole.

4. The wire adjustment plate as claimed in claim 1, wherein the holes are round or circular and the holes are all of the same diameter.

5. The wire adjustment plate as claimed in claim 1, wherein the holes define cylindrical shape with the axis of the cylinder parallel a notional normal of the plane of the plate.

6. The wire adjustment plate as claimed in claim 1, wherein the holes are positioned so as to form an equilateral triangular pattern together.

7. The wire adjustment plate as claimed in claim 1, wherein the wire adjustment plate is a metallic plate.

8. (canceled)

9. The wire adjustment plate as claimed in claim 1, wherein the wire adjustment plate is made out of a malleable material thereby allowing the wire adjustment plate to be deformed or bent when the force applied at each or at least one hole exceeds beyond a threshold amount of force.

10. The wire adjustment plate as claimed in claim 1, wherein the wire adjustment plate is configured to be used together with the wire as part of a support hanger system or an earthquake bracing system.

11. A support system for supporting at least one item by bracing, suspending and/or holding the at least one item, the system comprising:
a wire adjustment plate that is in a form of a single piece plate at a planar surface of which at least three see-through holes are defined, and
a wire to be received through each hole of the wire adjustment plate;
wherein the wire adjustment plate is configured to allow the wire to pass through each hole so that the wire supports the at least one item by bracing, suspending and/or holding the at least one item with equal distribution of force on the plate at each hole,
wherein the at least three holes are a first hole, a second hole and a third hole, the first hole being located above the second and third holes with distances between the first hole and the second hole and the first hole and the third hole being the same, and
wherein the wire is a metallic wire that allows a portion of the wire to clamp between another portion of the wire and the wire adjustment plate with a clamping force that facilitates supporting the at least one item by bracing, suspending and/or holding of the at least one item.

12. The support system as claimed in claim 11, wherein each hole is positioned, sized and shaped to allow the wire to pass through each hole for supporting the at least one item by bracing, holding and/or suspending the at least one item with equal distribution of force on the plate at each hole.

13. The support system as claimed in claim 11, wherein the wire adjustment plate is configured to allow the wire to pass through each hole so that the wire forms a loop for supporting the at least one item by bracing, suspending and/or holding the at least one item with at least six points of contact between the wire and the plate with two points of contact of the wire with the plate per hole.

14. (canceled)

15. (canceled)

16. (canceled)

17. (canceled)

18. (canceled)

19. A method of using a support system, a support hanger system or an earthquake bracing system for supporting at least one item by bracing, suspending and/or holding the at least one item, the method comprising:
providing a wire adjustment plate in a form of a single piece plate at a planar surface of which at least three see-through holes are defined, wherein the at least three holes are a first hole, a second hole and a third hole, the first hole being located above the second and third holes with distances between the first hole and the second hole and the first hole and the third hole being the same,
providing a wire,
passing the wire through each hole so that the wire supports at least one item by bracing, holding and/or suspending the at least one item with equal distribution of force on the plate at each hole.

20. The method as claimed in claim 19, wherein forming of the loop comprises at least the following steps in a sequential order:
passing a loose end of the wire through a first hole from a rear face side of the plate towards a front face side of the plate wherein the front face side is located opposite the rear face side,
passing the loose end of the wire through the second hole from the front face side towards the rear face side, and
passing the loose end of the wire through the third hole from the rear face side towards the front face side.

21. The method as claimed in claim 20, wherein the loose end of the wire is looped around at least a portion of the at least one item for supporting the at least one item by bracing, suspending and/or holding the at least one item prior to passing the loose end of the wire through the third hole from the rear face side towards the front face side.

22. The method as claimed in claim 21, wherein after the loose end of the wire is passed through the third hole from the rear face side towards the front face side, the loose end is passed through underneath an exposed portion of the wire that extends between the first hole and the second hole at the front face side of the plate so as to cause a portion of the wire located underneath said exposed portion to be clamped between said exposed portion and the front face side of the plate.

23. The method as claimed in claim 19, wherein the method comprises passing the wire through each hole so that the wire forms a loop for supporting the at least one item by bracing, suspending and/or holding the at least one item with at least six points of contact between the wire and the plate with two points of contact of the wire with the plate at each hole.

24. The method as claimed in claim 23, wherein a portion of the wire located underneath said exposed portion when clamped between said exposed portion and the front face side of the plate is a clamped portion of the wire, wherein the clamped portion forms a seventh point of contact between the wire and the plate.

25. The method as claimed in claim 20, wherein the method comprises engaging the wire via a second loose end of the wire to an external body so that the wire adjustment plate engages with or suspends from the external body.

26. The method as claimed in claim 25, wherein the external body is a ceiling or a wall of a building.

27.-30. (canceled)
